(19) United States
(12) Patent Application Publication
(10) Pub. No.: US 2026/0051233 A1
(43) Pub. Date: Feb. 19, 2026

(54) SYSTEM

(71) Applicant: SOFTBANK GROUP CORP., Minato-ku (JP)

(72) Inventor: Ayumi MORIGUCHI, Minato-ku (JP)

(73) Assignee: SOFTBANK GROUP CORP., Minato-ku (JP)

(21) Appl. No.: 19/299,862

(22) Filed: Aug. 14, 2025

(30) Foreign Application Priority Data
Aug. 16, 2024 (JP) 2024-137271

(51) Int. Cl. G08B 21/02; G06V 10/82; G06V 20/59; G06V 40/16; G06V 40/20

(52) U.S. Cl. CPC G08B 21/0205; G06V 10/82; G06V 20/59; G06V 40/172; G06V 40/20

(57) ABSTRACT

A system includes a processor that is configured to monitor the attendance status of children arriving at a childcare facility using a facial recognition camera, automatically contact guardians of children who have not arrived by a predetermined time, receive responses from the guardians and update the system based on the received responses, and notify caregivers when no response is received from guardians or when an abnormal situation is detected.

### CROSS-REFERENCE TO RELATED APPLICATION

This application is based on and claims priority under 35 USC 119 from Japanese Patent Application No. 2024-137271 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, ensuring the safety of children in childcare facilities and during their commute has become a significant concern due to incidents caused by human error, oversight, or insufficient monitoring. Conventional systems rely heavily on manual attendance checks and communication, which can result in delayed responses to emergencies or abnormal situations. There exists a need for an automated, reliable system that can monitor children's attendance and safety, facilitate timely communication with guardians, and promptly notify caregivers of any abnormalities.

### SUMMARY

The invention provides a system comprising a processor configured to monitor the attendance status of children using facial recognition cameras at childcare facilities, automatically contact guardians of children who have not arrived by a predetermined time, receive and process responses from guardians, and notify caregivers in cases of non-response or detected abnormalities. Additionally, the processor monitors children's boarding and behavior on school buses via in-bus cameras and employs AI technology to analyze data from these cameras, thereby enabling real-time safety monitoring and timely alerts to caregivers.

“Processor” means a central processing unit or computing element of the system, which executes programmed instructions to carry out the described functions of monitoring, communication, data processing, and alerting.

“Facial recognition camera” means an imaging device equipped with software for detecting, capturing, and identifying human facial features to distinguish individuals, specifically children in the context of the system.

“Attendance status” means information indicating whether a child has arrived at or is present in the childcare facility at a given time.

“Childcare facility” means an institution or establishment where children are cared for during the day, such as a nursery school, kindergarten, or preschool.

“Guardian” means a person who has legal responsibility for the care and well-being of a child, including parents or legal custodians.

“Predetermined time” means a specific, pre-set time by which certain actions, such as attendance confirmation or communication, are scheduled to occur.

“Caregiver” means an individual responsible for supervising and caring for children at the childcare facility, such as a teacher, nurse, or staff member.

“School bus” means a vehicle designated for transporting children between their homes and the childcare facility.

“In-bus camera” means a camera device installed inside the school bus for recording or monitoring the presence, behavior, or activities of children during transportation.

“AI technology” means artificial intelligence-based algorithms or methods, such as machine learning or pattern recognition techniques, are used for analyzing data collected by cameras to evaluate safety, detect anomalies, and support decision making.

“Abnormal situation” means any condition or circumstance that deviates from expected behavior or normal patterns, such as the absence of a child, lack of activity for an extended period, or any unusual event requiring caregiver intervention.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

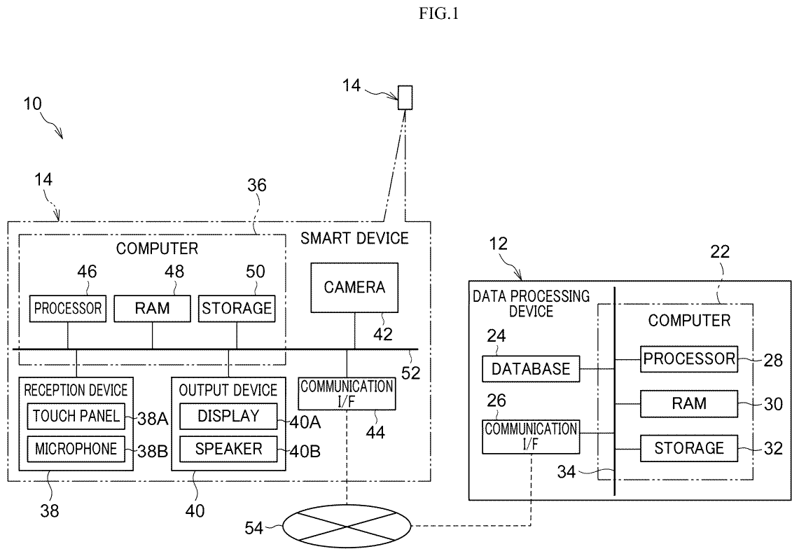

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

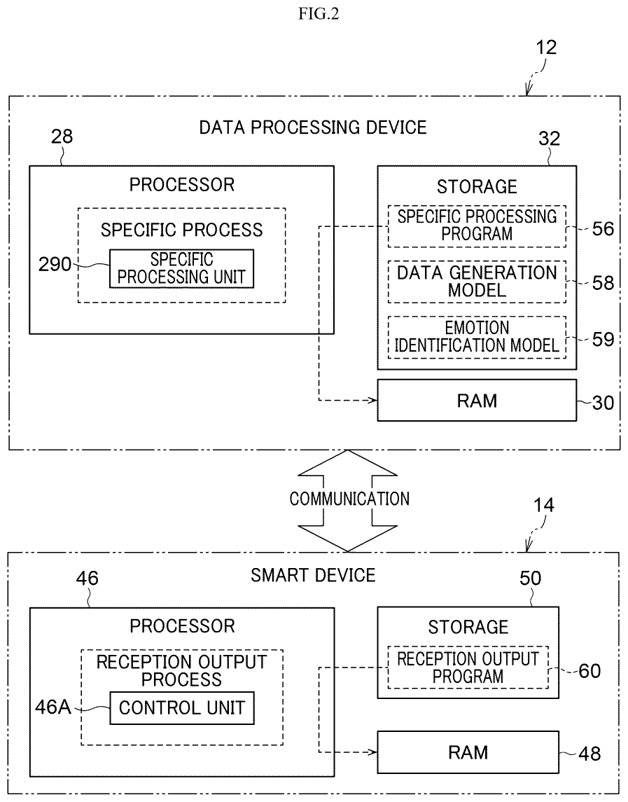

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional entry management and safety monitoring systems for facilities such as educational institutions or transport vehicles, monitoring the presence and well-being of individuals, as well as communicating with their supervisors, typically requires considerable manual effort by administrators. This not only increases the workload and possibility of human error but also delays the detection of abnormal situations such as unattended absences or unexpected behaviors during transportation. Furthermore, there is a need for generating appropriate and situation-specific notification messages efficiently without relying on manual composition. Therefore, there is a demand for a system that automates entry monitoring, abnormal situation detection, and notification processes in a secure, timely, and intelligent manner.

The specific processing by the specific processing unit 290 of the data processing device 12 in Example 1 is realized by the following means.

The present invention provides a server comprising a processor configured to monitor entry status of an entrant to a facility using a biometric identification device, automatically transmit notifications to supervisors when presence is not confirmed by a predetermined time, receive and process responses from supervisors, generate notification messages using a generative artificial intelligence model by inputting predetermined prompt sentences, monitor boarding time and behavior with an imaging device on a mobile vehicle, detect abnormalities, and transmit warnings to management terminals. This enables the automation of entry and safety monitoring, supervisor communication, and incident alerting with reduced administrative burden, increased reliability, and improved responsiveness to abnormal situations.

The term “biometric identification device” refers to a hardware apparatus or sensor configured to capture and analyze biometric information, such as facial features, fingerprints, or iris patterns, to identify or authenticate an individual.

The term “entrant” refers to a person whose presence, entry, or status is to be monitored within a facility or on a transportation vehicle.

The term “facility” refers to a physical location, such as an educational institution, childcare center, organization, or any similar establishment where the entry and presence of individuals are to be managed and monitored.

The term “supervisor” refers to a person who is legally or organizationally responsible for the entrant, such as a parent, guardian, or designated caretaker.

The term “electronic communication network” refers to a system for transmitting digital information, such as the Internet, mobile networks, or any other electronic means capable of delivering messages and notifications between devices.

The term “information management device” refers to a computing system or storage unit configured for organizing, updating, and maintaining information related to entrants and their attendance or safety status.

The term “information processing terminal” refers to an electronic device, such as a personal computer, tablet, or smartphone, used by management personnel to receive notifications, monitor status, and interact with the system.

The term “management personnel” refers to individuals responsible for the operation, supervision, or administration of the facility or transportation, such as caregivers, teachers, or staff members.

The term “generative artificial intelligence model” refers to a machine learning or artificial intelligence system capable of generating natural language text, such as personalized notification messages, in response to input data or prompts.

The term “prompt sentence” refers to an input instruction or textual query provided to the generative artificial intelligence model to specify the context or content required for generating a message.

The term “imaging device installed on a mobile vehicle” refers to a hardware unit, such as a camera or sensor, mounted on a transportation vehicle for capturing images or video to monitor the presence, boarding time, or behavior of entrants.

The term “mobile vehicle” refers to any form of transport, such as a bus, car, or van, used for conveying entrants to or from a facility.

The term “abnormality” refers to any condition or behavior that deviates from expected patterns of attendance, activity, or movement as determined by the system's monitoring and analysis functions.

The term “storage unit” refers to a component or subsystem of the information management device used to record, store, and retrieve attendance data, response messages, and analysis results.

An embodiment for carrying out the present invention will be described below.

A server is provided with a processor configured to manage identification, attendance, anomaly detection, and notification operations. The system includes one or more biometric identification devices, such as facial recognition cameras, installed at entry points of a facility. These devices may use hardware such as generic network cameras or edge computing modules (for example, industrial cameras or embedded systems like single-board computers), running software such as OpenCV with pre-trained deep neural network models for face recognition.

A server receives image data captured by each biometric identification device via a secure network, executes a face recognition algorithm, and compares identified facial features to entries in a registration database. The server may operate on a general-purpose or cloud-based computer running mainstream operating systems (for example, Linux or Windows Server), and employ database management systems like MySQL or PostgreSQL for storing and updating attendance and event data.

In the case where entry is not confirmed for a particular entrant by a predetermined time, the server is configured to transmit a notification about the absence to the corresponding supervisor using an electronic communication network. The server may utilize APIs for SMS, email, or push notification services, such as Twilio or Firebase Cloud Messaging.

The notification content is generated using a generative AI model. The server is provided with access to a generative AI model, such as GPT-4 or other large language models deployed locally or through a cloud API. The server creates a prompt sentence describing the context for the notification and provides this prompt to the generative AI model in order to create a situationally appropriate, natural language message. For example, the server may generate and submit the following prompt sentence to the generative AI model:

“Generate a polite message for the supervisor stating that their entrant, [Name], has not arrived at the facility by the designated time and requesting a reason for the absence.”

The generated message is then automatically transmitted to the supervisor's information processing terminal, which may be a mobile device or personal computer.

The system may further include an imaging device installed on a mobile vehicle, such as a bus or van, utilized for transporting entrants to or from the facility. This imaging device may be a camera with standard video recording and streaming capabilities. The device continuously monitors the boarding time and subsequent behavior of each entrant on board and transmits the collected data to the server. The server analyzes such data using AI-based image processing methods, including but not limited to object detection, activity recognition, or motion tracking algorithms.

When behavior inconsistent with expected activity (for example, no movement detected for a specified duration) or another abnormality is detected, the server generates an alert message, optionally using the generative AI model, and transmits this warning notification to an information processing terminal of the management personnel, such as a caregiver's smartphone, tablet, or desktop computer. The management personnel can then view live images or video feeds from the mobile vehicle's imaging device for further situational assessment and response.

Additionally, information received from supervisors, including responses to absence notifications, are processed by the server to update data records within the information management device's storage unit.

As a specific example, if an entrant does not arrive at the facility by 9:00 AM, the server detects the absence, generates a notification using the following prompt sentence: “Write a message to the supervisor explaining that their entrant has not checked in by 9:00 AM and requesting a brief explanation for the absence.”

The server sends the generated message to the supervisor, receives the response via the supervisor's app or portal, and updates the database. If no response is received within a defined period or an abnormality is otherwise detected (such as prolonged lack of movement in the vehicle), the server sends a warning message to the management personnel's device to prompt timely intervention.

This embodiment leverages commercially available hardware and software, established network protocols, and deployable generative AI solutions, such that persons skilled in the art may implement the invention without undue experimentation.

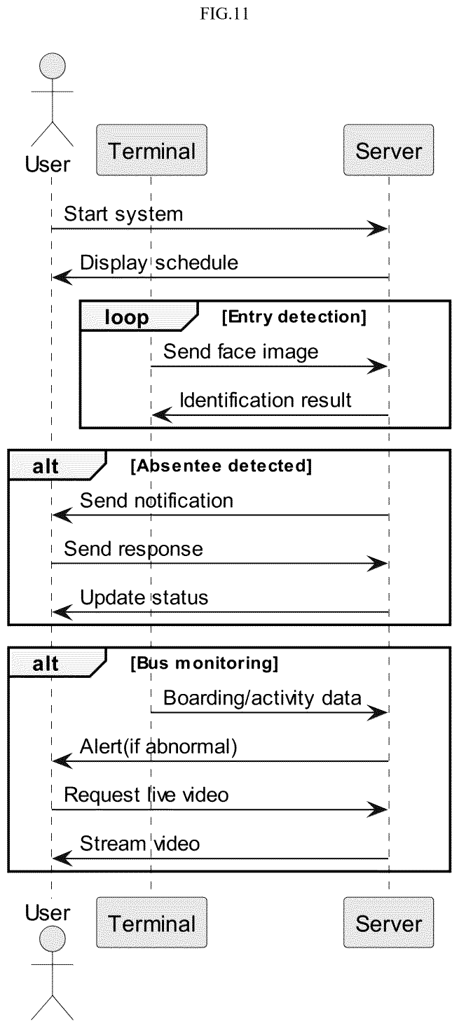

The following describes the processing flow using FIG. 11.

Step 1:

User (supervisor or management personnel) starts the system using an application on a personal computer or mobile device.

Input: User action (system start command), current date and schedule information.

The server receives the start command, accesses the schedule database, and retrieves the list of expected entrants for the day.

Output: Display of the schedule and list of entrants on the management terminal.

Concrete Action: The management personnel checks that system monitoring for today's attendance has started and that all expected entrants are listed.

Step 2:

Terminal (biometric identification device such as a face recognition camera) captures images of individuals as they attempt to enter the facility.

Input: Real-time image or video stream.

The terminal detects motion at the entry point and captures face images, then transmits these images to the server via a secure connection.

The server receives the image data and applies a face recognition algorithm to extract facial features. It compares the extracted data with the database of registered entrants.

Output: Identification or non-identification result, and update to the attendance database.

Concrete Action: If a match is found, the server updates the entrant's record as “present” and records the time of entry.

Step 3: Server checks for absent entrants at a predetermined time (such as 9:00 AM).

Input: Attendance database, system timer.

The server scans the attendance database for entrants who have not been marked “present” by the cutoff time.

Output: List of absent entrants.

Concrete Action: The server generates an absentee list and prepares for notification.

Step 4:

Server generates and sends notification messages to supervisors of absent entrants using a generative AI model.

Input: List of absent entrants, supervisor contact information.

The server generates a prompt sentence for each supervisor, such as:

“Write a message to the supervisor explaining that their entrant, [name], has not checked in by 9:00 AM and requesting a brief explanation for the absence.”

The server inputs the prompt sentence to the generative AI model and receives a personalized notification message. It then transmits this message to the supervisor via email, SMS, or app notification.

Output: Notification message delivered to each supervisor's terminal.

Concrete Action: The supervisor receives an alert and is prompted to respond.

Step 5:

User (supervisor) responds to the notification on their mobile device or PC.

Input: Response message from the supervisor.

The supervisor reads the message and replies, either by selecting a reason from a menu or entering free text.

The server receives the response via an API endpoint, processes the data, and updates the attendance record to reflect the supervisor's input (e.g., marking entrant as “absent—sick”).

Output: Updated attendance database and confirmation shown on the management terminal.

Concrete Action: The management personnel sees the updated attendance status for each entrant.

Step 6:

Terminal (imaging device installed on mobile vehicle) captures images or video data of entrants during boarding and while inside the vehicle.

Input: Video stream or images showing boarding events and in-vehicle activity.

The terminal detects and records when an entrant boards the vehicle, marking the time, and continues to monitor the behavior of the entrant during transit.

The captured data is sent to the server for analysis.

Output: Boarding time records and activity status data.

Concrete Action: The server logs boarding times and continuously receives behavior data for anomaly detection.

Step 7:

Server analyzes activity data from the vehicle to detect abnormalities, such as lack of movement for a certain period.

Input: Activity status data and video analysis results.

The server processes the received behavior data, using algorithms to detect if any entrant's activity is below a preset threshold (e.g., no movement for 20 minutes).

If an abnormality is detected, the server generates an alert message, optionally using the generative AI model.

Output: Alert notification sent to the management personnel's terminal.

Concrete Action: The management personnel is notified on their device and prompted to check the live vehicle feed or take appropriate action.

Step 8:

User (management personnel) receives the alert and accesses live video from the vehicle imaging device.

Input: Alert notification, request to access video feed.

The management personnel opens the notification on their application and requests a live stream.

The server authenticates the request and establishes a secure real-time video stream from the in-vehicle terminal to the management terminal.

Output: Live video feed displayed to the management personnel.

Concrete Action: The management personnel observes the situation in real time and may contact vehicle staff if necessary.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems for monitoring entry or boarding status and ensuring the safety of supervised individuals, such as children at facilities or on transportation apparatuses, are insufficient in providing real-time, accurate, and efficient notification, response collection, emotional state analysis, and abnormality detection. These shortcomings result in difficulties in timely intervention, increased burden on management staff, and a lack of comprehensive safety assurance for supervised individuals.

The specific processing by the specific processing unit 290 of the data processing device 12 in Application Example 1 is realized by the following means.

The present invention provides a server comprising a processor configured to monitor entry status or boarding status of supervised individuals using a biometric information acquisition device, automatically communicate with related parties, receive and process response information, perform emotional state analysis using generative models, detect abnormalities, and utilize artificial intelligence for safety monitoring. This enables real-time and automated management of entry or boarding, efficient and adaptive communication, prompt detection of emergencies or abnormal events, and comprehensive safety assurance for supervised individuals while reducing the workload on management staff.

The term “biometric information acquisition device” refers to an apparatus configured to capture and obtain biometric data such as facial images, physiological signals, or movement information from a supervised individual for identification or monitoring purposes.

The term “supervised individual” refers to a person whose entry, attendance, behavior, or safety is being monitored by the system, such as a child, passenger, or other person subject to supervision.

The term “facility” refers to any location or establishment where entry of supervised individuals is monitored, such as a childcare center, educational institution, or managed premises.

The term “transportation apparatus” refers to any means of transportation, including but not limited to vehicles, buses, or autonomous transport systems, in which the boarding and behavior of supervised individuals are monitored.

The term “related party” refers to a person who is responsible for or has a relationship with the supervised individual, such as a guardian, parent, or legal representative.

The term “processor” refers to a computing unit or microprocessor which executes instructions and performs logical, arithmetic, or data processing functions necessary for implementing system operations.

The term “storage” refers to any memory device or data repository used to store information, statuses, logs, and response data within the system.

The term “generative information model” refers to an information processing model, including but not limited to generative artificial intelligence algorithms, that is capable of automatically generating text or notification content based on input data or system context.

The term “notification text” refers to the content of a message automatically generated and communicated by the system to inform or request information from related parties or management staff.

The term “emotional state estimation” refers to the process of analyzing biometric or textual data to determine or infer the emotion, mood, or psychological state of a supervised individual or a related party.

The term “artificial intelligence” refers to computational technologies or algorithms, such as machine learning or deep learning methods, used to process data, recognize patterns, perform analysis, and support decision-making within the system.

The term “management staff” refers to personnel responsible for overseeing the safety, attendance, or behavior of supervised individuals, and for responding to notifications or abnormal events detected by the system.

The term “abnormal condition” refers to a state or event, such as inactivity or unexpected behavior, detected by the system which may indicate a potential risk or deviation from normal activity requiring prompt attention.

An embodiment for implementing the present invention is described as follows. The system comprises a server, a plurality of terminals equipped with biometric information acquisition devices, and user-side computing devices (such as smartphones or tablets) supporting a management application. The server acts as the central control and processing unit, while the terminals perform data acquisition at specific locations (such as facility entrances or inside transport vehicles). Users, such as management staff and related parties, interact with the system through a dedicated application.

The server includes a processor configured to execute software programs responsible for the following main functions:
Receiving and storing biometric data, such as facial images and motion data, acquired from the terminals' biometric information acquisition devices (for example, cameras equipped with high-sensitivity image sensors).
Performing identification and authentication of supervised individuals by applying a face recognition algorithm, such as those provided by OpenCV or TensorFlow, on the captured images.
Maintaining and updating an attendance or boarding status database within a general-purpose storage system (for example, a relational database management system).
Monitoring the status of supervised individuals according to schedules or predefined rules.

The terminal, such as a surveillance camera or facial recognition unit, is typically installed at entry points to a facility or within transportation apparatuses. The terminal operates by:
Continuously monitoring for the presence of individuals using motion sensors or image analysis.
Acquiring biometric data, including facial images, at prescribed time intervals or on detection of a target.
Preprocessing images on-device if necessary (for example, cropping faces using OpenCV).
Transmitting encrypted data to the server using standard communication protocols (such as via a 5G wireless module).

The server is further configured to automatically contact related parties (for example, guardians or custodians) in the event a supervised individual does not enter the facility or transport apparatus by a predetermined time. The server achieves this by:
Generating a prompt sentence for a generative AI model, such as a language model running in a cloud environment, to create a communication message customized to the specific context.
Example of a prompt sentence: “Compose a polite message for a guardian, asking why their child did not arrive by 9:00 AM.”
Receiving the generated notification text, such as: “Your child has not checked in at school today. Please let us know the reason.”
Sending this notification by means of a communication API (for instance, using a messaging gateway or push notification service) to the registered contact information of the related party.

The related party, acting as a user, receives the notification on their registered terminal, such as a mobile application or mobile device, and responds with the current status or reason for non-attendance or non-boarding.

The server receives and stores the response, optionally applying natural language processing and emotional state estimation. In one embodiment, the server can access an emotion recognition engine (for example, AffectNet or a cloud-based emotion API) to analyze the emotional status from facial images or text. The outcome, such as “worried” or “relieved,” is logged in the database.

Furthermore, the server is also configured to monitor ongoing biometric and behavioral data from the terminals. When abnormalities are detected, such as prolonged inactivity or atypical behavioral patterns, the server:
Generates an appropriate notification message, which may be auto-composed using the generative AI model.
Sends alerts to management staff (such as facility personnel) for timely intervention and verification.

For example, if a child is not detected in the classroom for a prolonged period after scheduled attendance, the following prompt may be sent to the generative AI model:

“Create an urgent notification for the supervisor to check on a child who has not responded for over 15 minutes.”

The management staff, as users, receive the notification and can confirm the situation through live video feeds or physical checks.

The server handles continuous data logging, ensuring all biometric data, status changes, communication logs, emotional analysis results, and intervention actions are recorded securely for audit and review.

The hardware used includes general-purpose servers (for example, x86-based cloud computers), high-sensitivity camera modules as biometric information acquisition devices (such as those using image sensors), communications hardware supporting wireless standards (such as LTE or 5G modules), and user-end smart devices compatible with mobile operating systems. The software stack comprises programming libraries for computer vision (such as OpenCV and TensorFlow), communication middleware (such as REST or WebSocket APIs), emotion analysis engines, and generative language models accessible via standard APIs.

In summary, this system utilizes coordinated server and terminal operations combined with advanced artificial intelligence technologies, including generative models and emotion recognition, to enable real-time, automated, and robust monitoring of supervised individuals and comprehensive safety management by facilitating adaptive communication and rapid response in diverse scenarios.

Examples of prompt sentences:
“Compose a message asking why the passenger has not boarded the vehicle by the scheduled time.”
“Generate an urgent follow-up alert to staff about a child with no attendance confirmation within 15 minutes.”
“Write a polite reminder for a guardian to explain their child's absence from preschool today.”

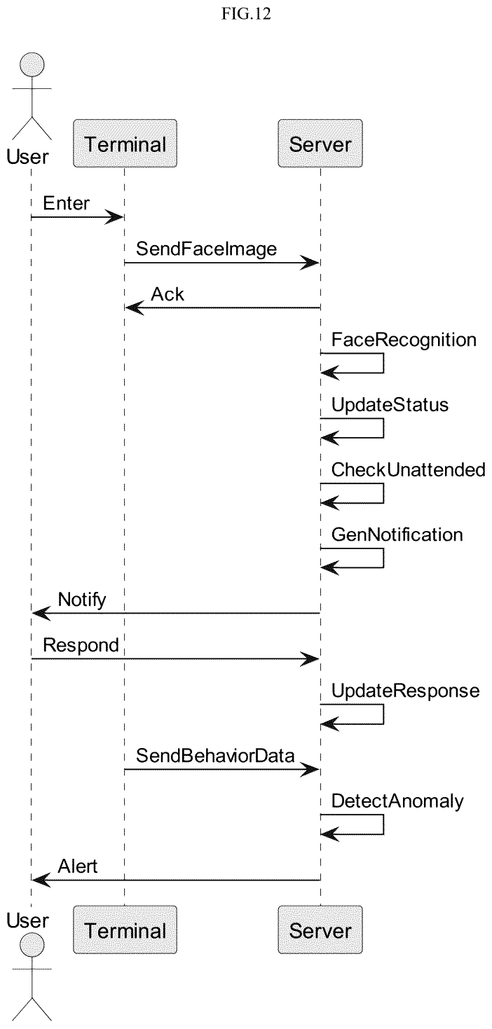

The following describes the processing flow using FIG. 12.

Step 1:

Terminal detects the approach of an individual at the entry point using a motion sensor or image analysis on the camera feed.

Input: Real-time camera video feed.

Processing: Terminal uses image recognition algorithms (for example, OpenCV) to identify when a person comes into frame.

Output: Trigger signal to capture a high-resolution image of the individual.

Step 2:

Terminal captures a high-resolution facial image of the individual and preprocesses the image to focus on the face region.

Input: Raw image data from the camera.

Processing: Terminal applies face detection and cropping using a computer vision library to extract the facial region.

Output: Cropped facial image data.

Step 3:

Terminal transmits the cropped facial image to the server over a secure wireless communication channel (such as 5G).

Input: Cropped facial image data.

Processing: Terminal encrypts and uploads the processed image to the server in real time.

Output: Transmitted image data received by the server.

Step 4:

Server receives the facial image and performs face recognition to identify the supervised individual by comparing the image against registered profiles.

Input: Cropped facial image data from terminal.

Processing: Server applies a face recognition model (such as TensorFlow or OpenCV) to extract features and match against database entries.

Output: Identification result, including individual's ID and recognition confidence.

Step 5:

Server updates the attendance or boarding status for the identified individual in the database, recording the timestamp and the location of entry.

Input: Individual's identification result and current database records.

Processing: Server modifies the database entry for the individual to reflect the current attendance or boarding state.

Output: Updated attendance or boarding database.

Step 6:

Server checks the database at predetermined times and identifies any individuals who have not been recorded as attended or boarded.

Input: Up-to-date attendance or boarding database and predefined schedule information.

Processing: Server performs a query to filter all individuals who are still marked as “not attended” or “not boarded” at the cutoff time.

Output: List of unattended or unboarded individuals with their respective contact information.

Step 7:

Server generates a prompt sentence for a generative AI model to create a customized notification message to communicate with the related party of each unattended/unboarded individual.

Input: List of unattended/unboarded individuals and message requirements (e.g., reason request).

Processing: Server formulates a prompt (such as “Compose a polite message for a guardian, asking why their child did not arrive by 9:00 AM.”), sends it to a generative AI model, and receives the generated text.

Output: Personalized notification messages for each related party.

Step 8:

Server sends the personalized notification messages to related parties through a communication platform (such as SMS gateway, messaging API, or in-app notification).

Input: Notification messages and related parties' contact details.

Processing: Server interfaces with external communication APIs to transmit the messages.

Output: Delivery of messages to users' smartphones or communication devices.

Step 9:

User receives the notification and sends a response indicating the current situation, such as reason for absence or delay, through the mobile application.

Input: Notification message on user device.

Processing: User enters text or selects options and submits a response through the app interface.

Output: User response sent to the server.

Step 10:

Server receives and parses the user response, updating the individual's database record with the new status and reason. Server may also forward the textual data to an emotion recognition engine.

Input: User response and current status database.

Processing: Server processes the data, stores the reason, updates attendance status, and analyzes emotional state if applicable.

Output: Updated database record and, if performed, emotional state information.

Step 11:

Terminal inside a facility or transport apparatus continuously streams behavioral data (such as video feed) to the server for ongoing monitoring.

Input: Real-time video feed or behavioral data from in-facility/in-vehicle cameras.

Processing: Terminal captures and uploads behavioral data at regular intervals.

Output: Continuous stream of behavioral monitoring data to the server.

Step 12:

Server analyzes incoming behavioral data using an AI-based anomaly detection algorithm to identify abnormalities such as prolonged inactivity or unusual movements.

Input: Behavioral data from terminals.

Processing: Server applies machine learning or pattern recognition models to detect deviations from normal behavior.

Output: Detection of anomaly events with associated individual and time stamps.

Step 13:

Server uses a generative AI model to generate an appropriate alert message for management staff when an anomaly is detected or when no response from the related party occurs within a predefined interval.

Input: Anomaly event information or non-response detection, together with alert requirements.

Processing: Server formulates a prompt (such as “Create an urgent notification for the supervisor to check on a child who has not responded for over 15 minutes.”), sends it to the generative AI model, and receives the generated alert text.

Output: Alert message to be delivered to management staff.

Step 14:

Server transmits the alert message to the management staff's terminal, prompting them to check the situation in real time.

Input: Alert message and management staff contact information.

Processing: Server sends the message via notification or SMS platform.

Output: Alert displayed on staff's device, leading to appropriate intervention.

It is also possible to incorporate an emotion engine for estimating the user's emotions.

That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional safety management systems in childcare facilities and commuting vehicles primarily focus on monitoring the presence or absence of protected subjects, such as children, without taking into account their emotional states or automating the communication process with supervisors. As a result, early detection of abnormal events or risk conditions that involve emotional distress is insufficient, and the administrative workload for staff members remains high due to manual notification and response tracking. There is a need for an advanced system capable of real-time monitoring, emotional state analysis, efficient communication with supervisors, and automated response management to enhance safety and reduce the burden on facility staff.

The specific processing by the specific processing unit 290 of the data processing device 12 in Example 2 is realized by the following means.

The present invention provides a server comprising a processor configured to monitor the status of a protected subject entering a facility via an imaging device, automatically transmit notification information to a supervisor if the subject does not arrive by a predetermined time, receive and process supervisor responses to update attendance records, generate alerts to staff when no response or an abnormal condition is detected, analyze emotional states using image and text data, and create communication content using a generative artificial intelligence model. This enables real-time safety monitoring, automated communication, early detection of emotional or behavioral abnormalities, and reduction of manual administrative work in childcare and facility environments.

The term “processor” refers to a hardware or software component capable of executing instructions and performing data processing tasks within the system.

The term “imaging device” refers to an apparatus such as a camera or a sensor configured to capture visual information, including images or video streams, of subjects or environments.

The term “subject under protection” refers to an individual, such as a child or other person, who is being monitored for safety and well-being within a facility or vehicle.

The term “facility” refers to an establishment or location, such as a childcare center, school, or similar institution, where subjects under protection are supervised.

The term “supervisor” refers to a person responsible for the oversight and care of the subject under protection, such as a parent, guardian, or staff member.

The term “communication device” refers to any hardware, software, or network interface that enables the electronic transmission of information, including notifications and messages, between the system and supervisors.

The term “notification information” refers to data or messages generated by the system to inform a supervisor of an event or status related to the subject under protection, such as unreported arrival or detected abnormalities.

The term “response information” refers to data or messages sent from a supervisor to the system in reply to a received notification.

The term “management information” refers to data stored in a memory device that includes attendance records, emotional states, responses, and other administrative data related to monitoring the subject under protection.

The term “memory device” refers to storage hardware or media used for recording and maintaining management information or other data essential for system operation.

The term “staff terminal” refers to an electronic device, such as a computer, tablet, or smartphone, operated by facility staff to interact with the system, view alerts, and manage information.

The term “sensor information” refers to data acquired from various types of sensors, including imaging devices and motion detectors, related to the status or activity of a subject under protection.

The term “analysis processing” refers to computational methods applied to sensor or system data to detect abnormalities or to evaluate emotional states.

The term “warning information” refers to alert data or messages presented to staff terminals when a noteworthy condition, such as lack of supervisor response or abnormal behavior, is detected.

The term “analysis device” refers to a component or module configured to process image and text data to assess the emotional state or behavior of subjects and supervisors.

The term “emotional state” refers to a psychological condition, such as happiness, anxiety, or concern, inferred from facial expressions, behavior, or textual communication.

The term “natural language processing device” refers to a system or software configuration capable of interpreting, analyzing, and generating human language, particularly for the automation of communications.

The term “generative artificial intelligence model” refers to a computational model, based on machine learning or deep learning architectures, designed to produce natural language or content automatically, such as generating messages or notifications.

The term “moving object” refers to a conveyance, such as a vehicle or transport mechanism, equipped with an imaging device to acquire information related to the subject under protection during transit.

The term “getting-on/off time” refers to the recorded time when a subject under protection enters or exits a moving object.

The term “behavior information” refers to data reflecting the actions, movements, or patterns of activity of a subject under protection as observed and recorded by the system.

The term “recognition processing device” refers to a module or software component that applies identification, classification, or interpretation algorithms to data captured by imaging devices.

### Embodiment for Implementing the Invention

The present invention can be implemented as a system in which a server, one or more terminals equipped with imaging devices, and user-operated terminals communicate over a network to monitor the status and emotional state of a subject under protection, such as a child, within a facility or on a moving object, such as a vehicle.

The server comprises a processor, memory device, communication interfaces, and appropriate software modules. The server may be realized using general-purpose computing hardware, such as a workstation or cloud server, that executes application logic developed in languages such as Python or Java. The server is connected to a relational database management system, such as PostgreSQL, for storing management information, attendance records, images, and emotional state data.

The imaging devices installed at facility entrances and within moving objects (such as buses or vans) serve as terminals. Each terminal includes a camera (for example, a USB camera or a built-in module), local processing units such as an embedded computing board (for example, a board with NVIDIA Jetson or Raspberry Pi), and network interface circuitry. The software on each terminal includes an image-capture routine (for example, utilizing OpenCV), a timestamping function, and code for securely transmitting data to the server via HTTP or a similar protocol.

The server receives image data and performs facial recognition through a trained face recognition library such as dlib or a convolutional neural network implemented using a deep learning framework like TensorFlow or PyTorch. The server identifies the subject under protection by comparing extracted facial features with stored templates in the database.

The server also analyzes the emotional state of the subject under protection and, where applicable, the supervisor's response text using an emotion engine. The emotion engine may be implemented via an external cloud service, such as Microsoft Azure Face API for facial emotion analysis, or via a locally deployed deep learning model for both image and text data.

For automated communication, the server incorporates a generative AI model, such as an LLM (large language model) obtained through an external API (for example, OpenAI API) or deployed locally using an open-source framework (such as Hugging Face Transformers). The generative AI model creates context-sensitive communication content in natural language, based on prompt sentences and related information stored by the server.

A communication device, such as a mobile network router or internet-connected gateway, facilitates transmission of notifications and alerts to supervisors (e.g., parents or guardians) and facility staff. Notification information, generated automatically by the server, is sent via SMS, mobile push notification, or email using platforms such as Twilio or Firebase Cloud Messaging.

User terminals, such as smartphones, tablets, or personal computers, are provided to supervisors and staff for interaction with the system. Supervisors receive notifications through a dedicated app or web interface and may respond with free-text messages. These responses are relayed to the server, which updates attendance records and further analyzes the emotional tone of the replies. Facility staff access an administrative dashboard via computer or tablet to monitor the safety status, visualize emotional states, and receive alerts.

All critical events, such as unreported arrivals, emotional distress, inactivity over a set interval detected by terminal cameras, or lack of supervisor response within a predetermined period, result in the server issuing warning information to designated staff through their terminals.

A concrete example of a prompt sentence for the generative AI model used by the server is as follows:

“Your child has not arrived at the facility today. Could you please provide the reason for their absence?”

Implementing the system in this manner allows the real-time and comprehensive management of safety and emotional well-being for subjects under protection, automatic and contextually appropriate communication with supervisors, and efficient response coordination among facility staff.

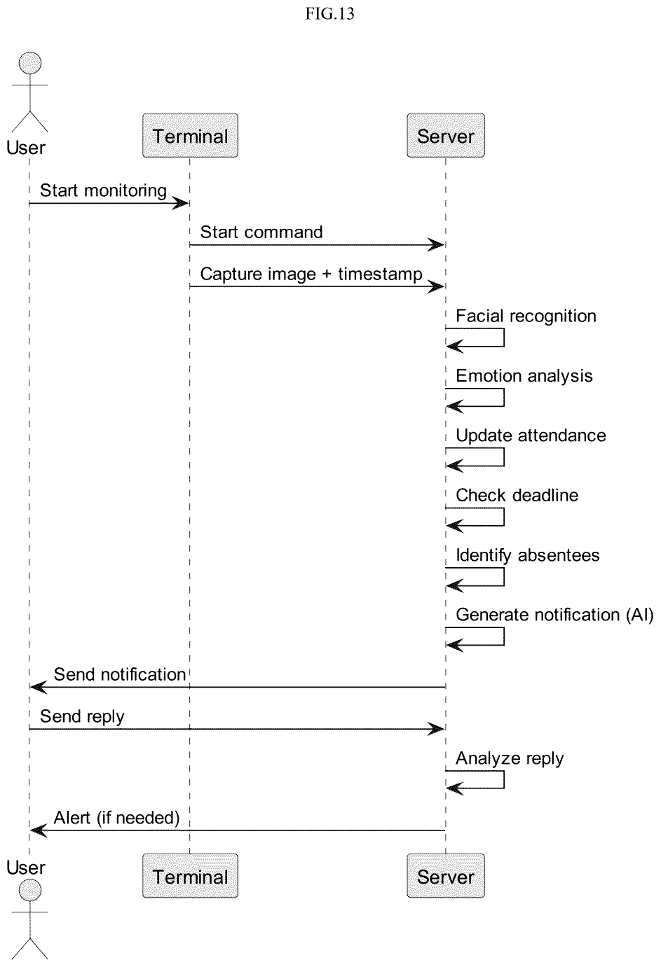

The following describes the processing flow using FIG. 13.

Step 1:

User launches the monitoring application on a terminal device, such as a tablet or PC, and initiates the start of a new attendance monitoring day.

Input: User command (start monitoring), current date.

The terminal transmits the start command and relevant metadata to the server.

Server processes the request by querying the database for the attendance schedule matching the current date and preparing the system for new data input.

Output: Monitoring readiness confirmation displayed to the user; attendance schedule loaded in server memory.

Step 2:

Terminal (imaging device at entrance) detects the arrival of a subject under protection using a motion sensor and captures the subject's facial image, attaching a timestamp based on the local system clock.

Input: Detected motion event.

The terminal executes an image capture routine, processes the image for clarity, applies a timestamp, and securely transmits the image and timestamp data to the server.

Output: Image data with timestamp sent to the server.

Step 3:

Server receives facial image data and timestamp, then initiates facial recognition processing using a facial recognition library.

Input: Facial image, timestamp.

Server extracts facial features and compares them with registered facial templates in the database to identify the subject.

Output: Identification result (subject ID or no match); attendance database updated with arrival record (if identified).

Step 4:

Server passes the facial image data to the emotion analysis engine, which may be a cloud-based service or a local neural network, to infer the emotional state of the subject.

Input: Facial image, subject ID.

The emotion analysis engine processes the facial image for expression features, applies an emotion recognition algorithm, and returns an emotional state label (such as happy, anxious, or sad).

Output: Emotional state label and confidence score; attendance record updated with the emotional state.

Step 5:

Server monitors the arrival status of all subjects by comparing real-time attendance logs to the loaded schedule and the specified arrival deadline.

Input: Attendance records, schedule, current time.

At the deadline, the server processes attendance data to identify all subjects who have not checked in and compiles a list of absentees.

Output: List of absentees generated for further processing.

Step 6:

Server generates notification content for each absentee's supervisor using a generative AI model. The server forms a prompt sentence for the AI model using attendance data, subject name, and relevant context.

Input: Absentee list, attendance data, prompt template.

Server calls the generative AI model, provides the context, and receives a personalized notification message.

Server sends the notification to each supervisor via SMS, push notification, or email.

Output: Personalized notification messages generated and transmitted to supervisors; logs updated.

Step 7:

User (supervisor) receives the notification on their mobile device and replies with the reason for the absence.

Input: Notification message, supervisor reply.

The supervisor's reply is transmitted to the server through the communication application.

Output: Reply message sent to the server and recorded in the database.

Step 8:

Server processes the supervisor's reply by storing the textual data, updating the absentee's record, and analyzing the emotional tone using a natural language processing module or the generative AI model.

Input: Supervisor's reply message.

Server analyzes the reply to determine the emotional state (for example, worried or calm), associates the result with the attendance record, and flags entries requiring special attention.

Output: Updated attendance record, emotional state assessment, and flagged entries for staff review.

Step 9:

Server continuously monitors for any absentees for whom no supervisor response has been received within a predetermined interval, or for abnormal events detected by terminals (such as inactivity on a moving object).

Input: Attendance records, reply timestamps, sensory/motion data from terminals.

Server runs scheduled jobs to check for overdue responses and applies anomaly detection algorithms to behavioral data. If a problem is identified, the server generates and sends an alert to staff terminals with details about the issue.

Output: Alert message sent to staff terminal regarding no response or detected abnormal behavior; issue logged for follow-up.

Step 10:

User (staff) receives an alert on their terminal, reviews the subject's information and any linked video or data, and undertakes the necessary follow-up actions (such as direct observation or contacting the supervisor).

Input: Alert message, subject information, supporting video/data.

Staff interacts with the monitoring dashboard, reviews details, and records actions taken.

Output: Follow-up action recorded by the server; monitoring records updated to reflect staff response.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional worker management systems have significant limitations in effectively monitoring the attendance status and the physical and mental well-being of operators, making it difficult for supervisors to promptly respond to abnormal situations. In particular, existing systems do not automatically detect signs of fatigue or mental stress in operators based on biometric and behavioral data, nor do they promptly notify administrators or supervisors in the event of an abnormal condition. Furthermore, the monitoring of operators during boarding or during transport is inadequate, which increases the risk to operator safety and can lead to delayed interventions in emergency situations.

The specific processing by the specific processing unit 290 of the data processing device 12 in Application Example 2 is realized by the following means.

The present invention provides a server comprising a processor configured to monitor attendance status of operators using a biometric authentication device, contact supervisors automatically if operators do not arrive by a designated time, receive and process responses from supervisors, notify administrators when there is no response or when abnormalities are detected, analyze biometric and behavioral data using an analysis engine to detect signs of fatigue or mental stress, and automatically transmit alerts when an abnormal condition is detected. The processor is further configured to monitor boarding times and operator behavior using biometric devices installed in transportation apparatuses, and utilize machine learning to ensure operator safety. This enables real-time, automated monitoring and notification of operator status and health conditions, allowing for faster intervention and improved safety management in various workplaces.

The term “biometric authentication device” refers to a device capable of identifying or verifying the identity of an individual using physiological or behavioral characteristics, such as facial features, fingerprints, iris patterns, or voice.

The term “attendance status” refers to the recorded information regarding whether an operator has entered or exited a facility, including the corresponding times of arrival and departure.

The term “operator” refers to a person who performs work or tasks within a facility or on-site environment.

The term “facility” refers to a physical location or building where operations or tasks are carried out by operators.

The term “supervisor” refers to an individual who is responsible for overseeing, managing, or supervising operators within a facility or work environment.

The term “administrator terminal” refers to an information processing device, such as a computer, smartphone, or tablet, that is used by a system administrator or manager to receive notifications and manage system-related events.

The term “information processing device” refers to a computing apparatus, such as a server or workstation, capable of receiving, storing, processing, and transmitting data relating to the operators, supervisors, and overall system operation.

The term “abnormal condition” refers to any situation or detected event that deviates from expected operator behavior or health status, including but not limited to fatigue, stress, inactivity, or failure to arrive on time.

The term “analysis engine” refers to a software or hardware component configured to process biometric and behavioral information to determine the physical or mental state of an operator.

The term “fatigue” refers to a state in which an operator exhibits physical or mental tiredness that could impair their ability to perform tasks safely or effectively.

The term “mental stress” refers to a psychological condition experienced by an operator due to workload, environment, or other factors, which may negatively affect their health or performance.

The term “boarding time” refers to the point in time when an operator enters a vehicle or transportation apparatus for the purpose of work-related movement.

The term “transportation apparatus” refers to any vehicle or conveyance used to transport operators to, from, or within work sites or facilities.

The term “machine learning” refers to a computational approach in which algorithms are trained on data so as to find patterns and make predictions or decisions without being explicitly programmed for each possible scenario.

### Embodiment for Implementing the Invention

This invention may be embodied in a system comprising a server, one or more terminals equipped with biometric authentication devices, and administrator user terminals. The server is implemented as a central computing device, such as a high-performance computer or cloud instance, for example, a general-purpose workstation or a virtual machine instance on a cloud platform. The biometric authentication devices may include cameras utilizing facial recognition technology and may be integrated into access points at a facility or within a transportation apparatus. Administrator user terminals may consist of smartphones, tablet computers, or personal computers capable of receiving notifications and displaying relevant information.

The server operates appropriate software, including a database management system such as SQLite, a biometric recognition library such as OpenCV for facial analysis, and a custom analysis engine for processing behavioral and physiological information. Machine learning-based analysis software may be utilized to detect signs of fatigue or mental stress from real-time operator data. The notification subsystem may utilize standard push notification services or email gateway modules.

In operation, the terminal captures biometric information of an operator, such as a facial image, when the operator enters or exits the facility or transportation apparatus. The terminal transmits this image data to the server via a secure communication channel. The server processes the received image using the biometric recognition software to identify the operator and updates the attendance status in the database. When the operator does not arrive by a prescribed time, the server automatically transmits a notification to the responsible supervisor. If a response is received from the supervisor, the server updates the information processing device accordingly. If no response is received, or if an abnormal condition such as fatigue or mental stress is detected by the analysis engine, the server sends an alert notification to the administrator terminal.

For example, a camera positioned at the entrance of a logistics center captures images of operators as they arrive for work. The server executes the face detection and recognition functions using the biometric library, records the time of entry in the database, and analyzes operators' expressions via the analysis engine. When worker fatigue is detected, the server issues a real-time alert to an administrator's smartphone, prompting an immediate response. Similarly, a biometric authentication device installed in a vehicle records the boarding time and monitors the operator's state during transport, while inactivity or abnormality triggers immediate notification to the administrator.

The system supports implementation using general-purpose hardware with widely available components. The biometric authentication device can be, for example, a network camera that supports real-time data transfer. The administrator terminals can be any information device capable of displaying messages and handling notifications. The server software can be written in standard programming languages and may be executed on any general-purpose operating system.

A representative prompt sentence for a generative AI model that can create the necessary program for this system is as follows:

“Generate a Python program for a worker health and safety monitoring system used in a warehouse. The program should use a camera for biometric capture, a facial recognition library such as OpenCV, and a custom analysis engine for emotion and fatigue detection. SQLite should be used for attendance and analysis record management. If the analysis engine detects fatigue or stress above a threshold, the system should send a push notification to the manager, who can respond through the system. The program should implement database operations, camera integration, biometric analysis, alerting, and logging of manager responses.”

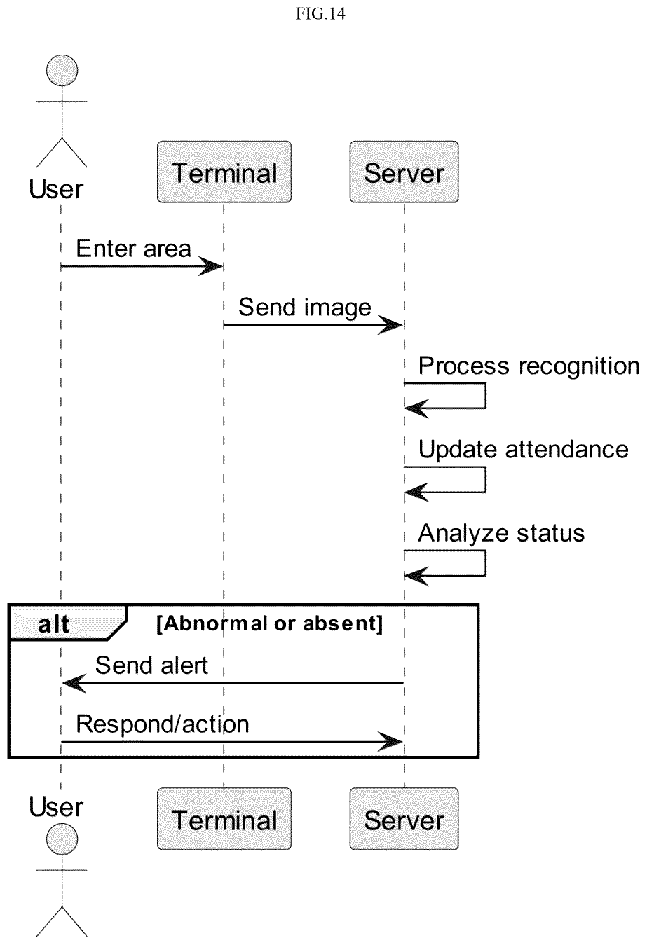

The following describes the processing flow using FIG. 14.

Step 1:

The terminal detects the presence of an operator near the entry point of the facility or transportation apparatus. The terminal captures a biometric image, such as a facial photograph, using its camera. The input for this step is the live video or image stream from the biometric device, and the output is a captured facial image file with a timestamp. The terminal then transmits this image data to the server via a secure network connection.

Step 2:

The server receives the transmitted facial image data. Using a biometric recognition library, the server processes the input image data by extracting facial features. The server compares these features to registered templates stored in the database to identify the operator.

The input is the image file from the terminal, and the output is the identified operator's ID along with the detection timestamp. The server logs this result for further processing.

Step 3:

The server checks the attendance status using the operator's ID and the current time. The server updates the attendance database to reflect whether the operator has arrived or boarded at the expected time. The input is the identified operator's ID and timestamp, and the output is an updated attendance record in the database. The server executes an INSERT or UPDATE operation in the attendance data table to record the event.

Step 4:

The server analyzes the operator's biometric and behavioral data using the analysis engine. The input is the captured image and recent actions or behavioral data (such as frequency of entries or detected activity patterns). The server performs data analysis to determine if there are signs of fatigue or mental stress, and the output is an assessment result, such as a fatigue score or stress indicator, recorded along with the operator's ID in the database.

Step 5:

The server evaluates whether the analysis result indicates an abnormal condition by comparing the score to predefined thresholds. If an abnormality is detected or if the operator is absent past a set time, the server generates a notification message. The input is the analysis result or attendance data, and the output is a structured alert or notification message. The server sends this message to either the supervisor or the administrator terminal using push notification or email.

Step 6:

The user (administrator or supervisor) receives the notification on their designated terminal. The input is the alert or message from the server. The user reads the notification details and, if needed, provides a response or takes action, such as instructing the operator to take a rest. The output is the actual action taken, which may include sending a response message or recording the action through the terminal's interface.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc.

The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

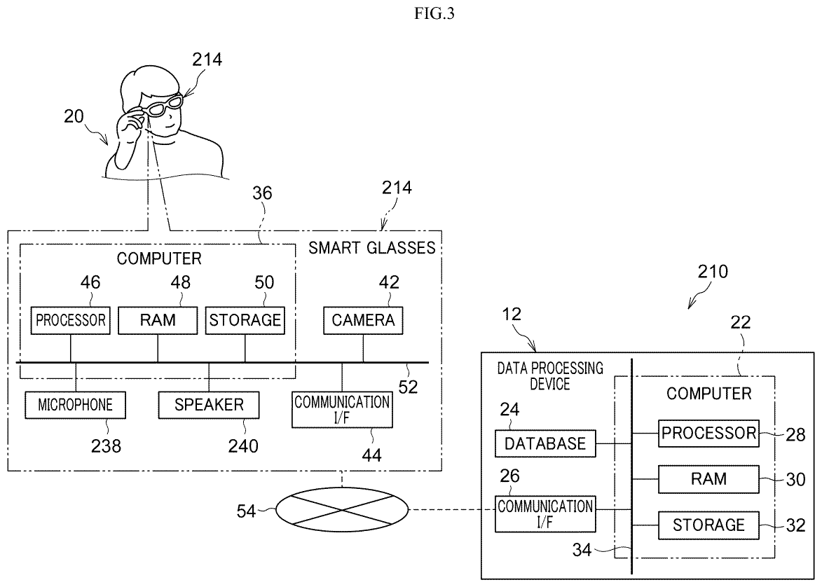

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52.

The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

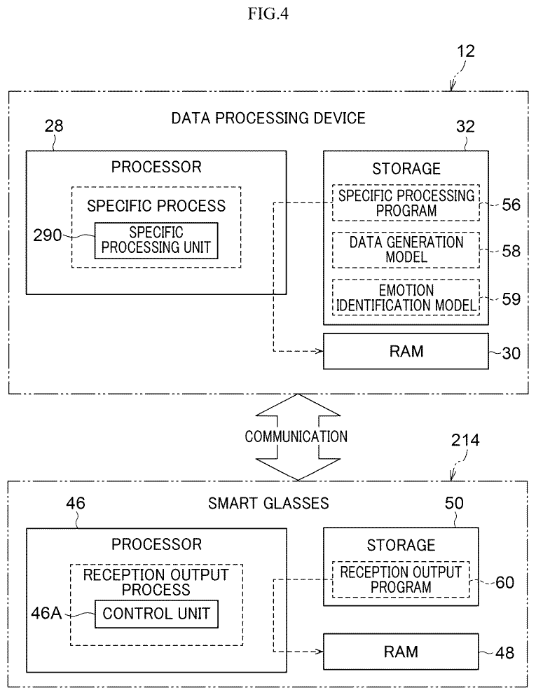

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

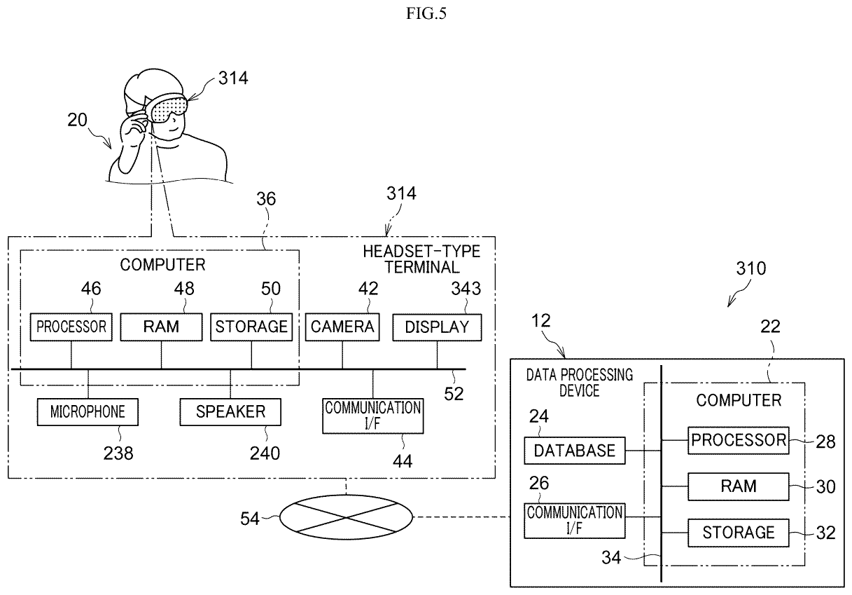

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

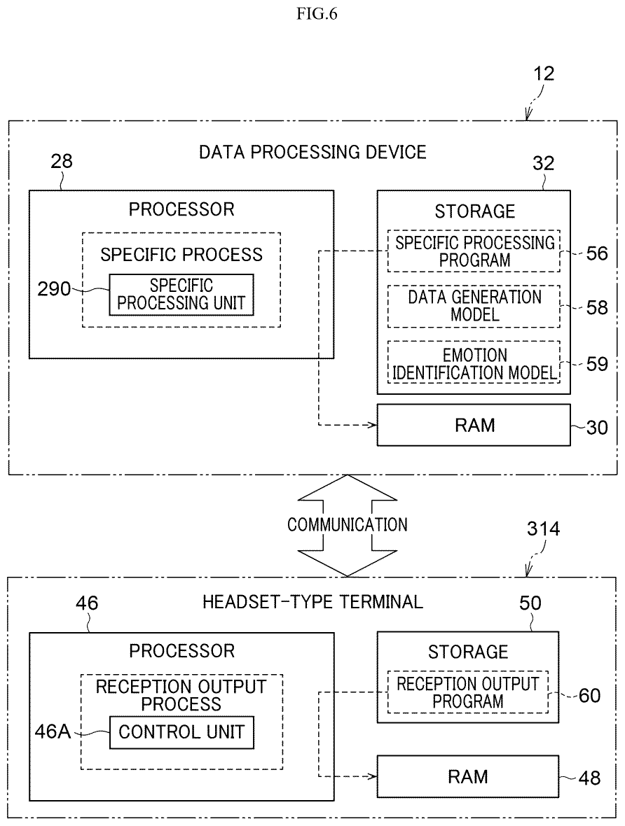

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc.

The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

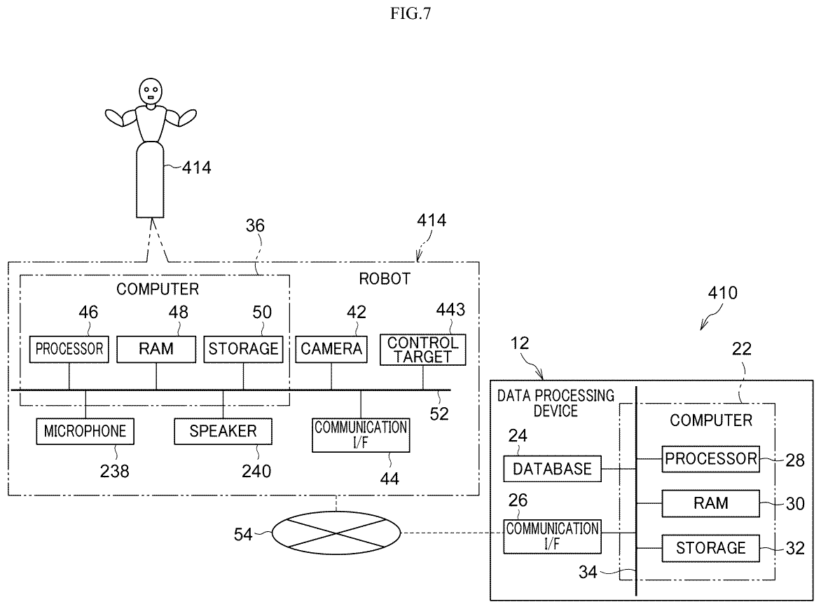

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

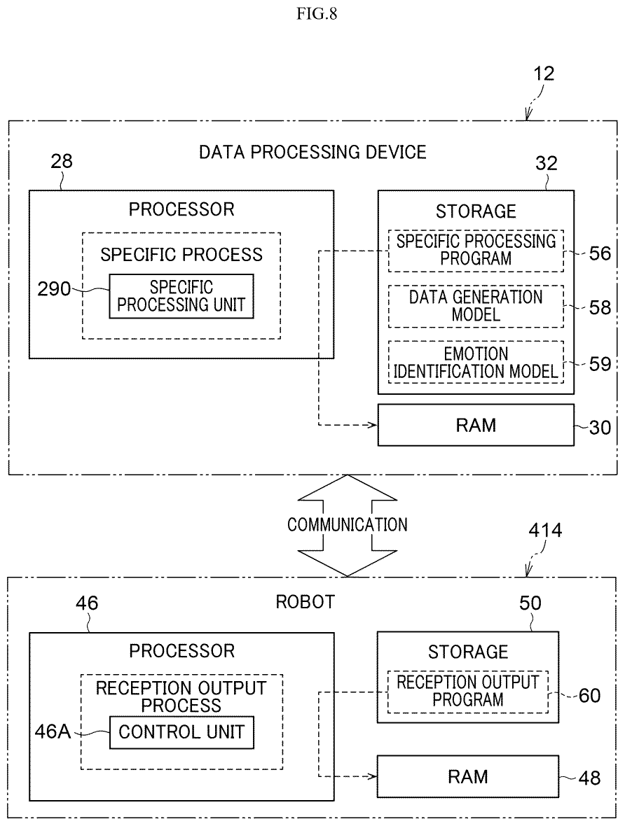

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

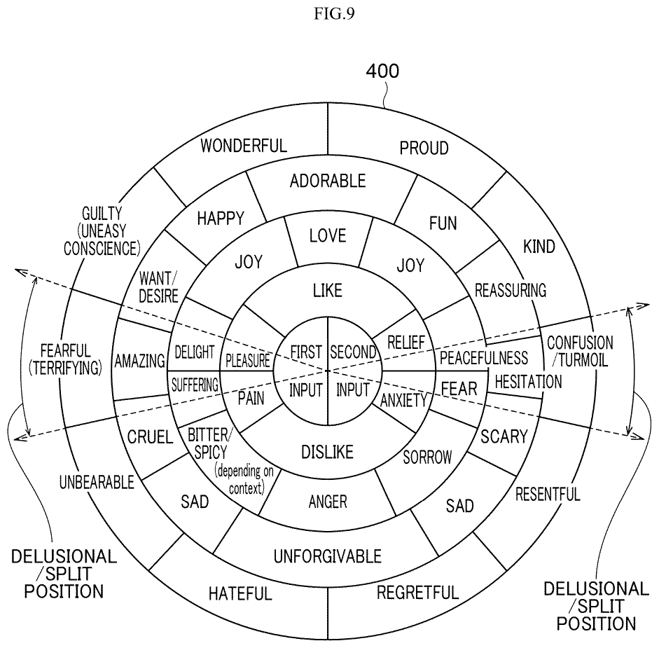

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

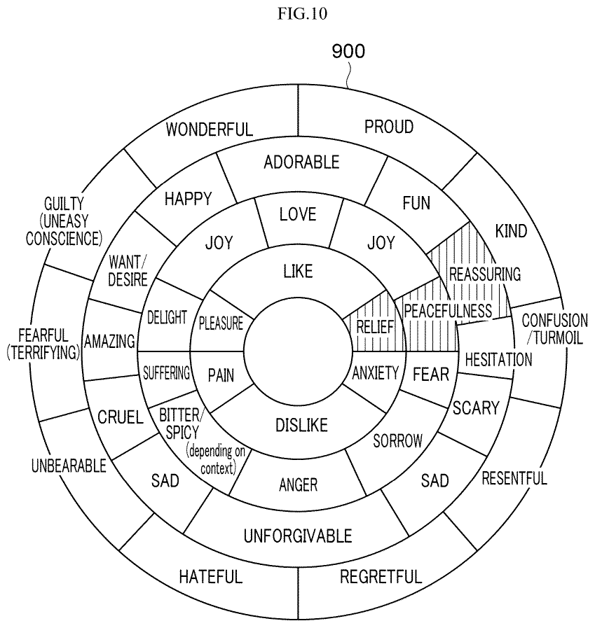

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
monitor entry status of an entrant to a facility using a biometric identification device,
automatically transmit a notification to a supervisor of the entrant, through an electronic communication network, when the entrant's entry is not confirmed by a predetermined time,
receive response information from the supervisor and update a storage unit within an information management device based on the response information,
transmit a warning notification to an information processing terminal of a management personnel when the processor does not receive a response information from the supervisor within a predetermined time or detects an abnormality,
generate an electronic message for notification using a generative artificial intelligence model, and
input a predetermined prompt sentence to the generative artificial intelligence model for generating a sentence for notification.

### (Supplementary 2)

The system according to supplementary 1,
wherein the processor is configured to
monitor boarding time and behavior of the entrant using an imaging device installed on a mobile vehicle, and
transmit a warning notification to the information processing terminal of the management personnel when the monitored behavior does not meet a predetermined condition or when an abnormality is detected.

### (Supplementary 3)

The system according to supplementary 1,
wherein the processor is configured to utilize artificial intelligence technology to process information obtained from the biometric identification device and the imaging device installed on the mobile vehicle to perform safety management of the entrant.

### Application Example 1

### (Supplementary 1)

A system comprising a processor,
wherein the processor is configured to
monitor an entry status of a supervised individual to a facility using a biometric information acquisition device,
automatically perform communication to a related party of the supervised individual who has not entered by a predetermined time,
receive a response information from the related party and update a storage based on the response information,
notify a management staff when the response information from the related party is not received within a predetermined period or when an abnormal condition is detected, automatically generate a notification text using a generative information model, and
perform an emotional state estimation based on the acquired biometric information or response information.

### (Supplementary 2)

The system according to supplementary 1,
wherein the processor is configured to
monitor a boarding time or behavioral status of the supervised individual in a transportation apparatus using the biometric information acquisition device, and
notify a management staff when inactivity or an abnormal condition is detected based on the boarding time or behavioral status.

### (Supplementary 3)

The system according to supplementary 1,
wherein the processor is configured to
utilize artificial intelligence to process information acquired from the biometric information acquisition device or the information acquisition device installed in the transportation apparatus, in order to monitor safety of the supervised individual.

### Example 2

### (Supplementary 1)

A system comprising a processor,
wherein the processor is configured to
monitor the status of a subject under protection entering a facility using an imaging device,
automatically transmit notification information to a supervisor of the subject under protection who has not entered the facility by a predetermined time using a communication device,
receive response information from the supervisor and update management information stored in a memory device based on the response information,
output warning information to a staff terminal when a response from the supervisor is not received within a predetermined period or when an abnormality is detected based on sensor information or analysis processing,
analyze the emotional state of the subject under protection or the supervisor based on captured image information using an analysis device and detect an abnormal state according to the emotional state, and
automatically generate communication content or notification information using a natural language processing device or a generative artificial intelligence model.

### (Supplementary 2)

The system according to supplementary 1,
wherein the processor is configured to
acquire, using an imaging device mounted on a moving object, getting-on/off time or behavior information of the subject under protection, perform state analysis based on the acquired information, and
notify warning information to the staff terminal when inactivity or abnormal activity is detected in the acquired behavior information.

### (Supplementary 3)

The system according to supplementary 1,
wherein the processor is configured to
analyze the safety state of the subject under protection by applying a recognition processing device or artificial intelligence technology using image information or behavior information obtained from the imaging device.

### Application Example 2

### (Supplementary 1)

A system comprising a processor,
wherein the processor is configured to
monitor attendance status of operators entering and exiting a facility using a biometric authentication device,
automatically contact a supervisor of an operator if the operator does not arrive by a prescribed time,
receive a response from the supervisor and update an information processing device based on the response,
notify an administrator terminal when no response is received from the supervisor or when an abnormal condition is detected,
analyze biometric information and behavioral information of the operator using an analysis engine to detect signs of fatigue or mental stress, and
automatically transmit alert information to the administrator if an abnormal condition is detected by the analysis engine.

### (Supplementary 2)

The system according to supplementary 1,
wherein the processor is configured to
monitor the boarding time and behavior of the operator using a biometric authentication device installed in a transportation apparatus, and
notify the administrator terminal when no activity is detected for a prescribed period or when an abnormal condition is detected.

### (Supplementary 3)

The system according to supplementary 1,
wherein the processor is configured to
use machine learning techniques to process information from the biometric authentication device and the biometric authentication device installed in the transportation apparatus to monitor the safety of the operator.

What is claimed is:

1. A system comprising a processor,
wherein the processor is configured to:
monitor the attendance status of children arriving at a childcare facility using a facial recognition camera;
automatically contact guardians of children who have not arrived by a predetermined time;
receive responses from the guardians and update the system based on the received responses; and
notify caregivers when no response is received from guardians or when an abnormal situation is detected.

2. The system according to claim 1, wherein the processor is further configured to: monitor the boarding time and behavior of children using a camera installed on a school bus for the childcare facility; and
notify caregivers when no activity is detected for a predetermined period or when an abnormal situation is detected.

3. The system according to claim 1, wherein the processor is further configured to use AI technology to process data from the facial recognition camera and the camera installed on the school bus, and to monitor the safety of the children.
